(19) United States
(12) Patent Application Publication
(10) Pub. No.: US 2024/0356887 A1
(43) Pub. Date: Oct. 24, 2024

(54) SENDING DNS TRAFFIC DIRECTLY FROM END USER DEVICE TO SERVICE-SPECIFIC DNS SERVER

(71) Applicant: Microsoft Technology Licensing, LLC, Redmond, WA (US)

(72) Inventors: Rajesh MASKARA, Seattle, WA (US); Boyang ZHENG, Suzhou, Jiangsu (CN); Bradley RUTKOWSKI, Woodinville, WA (US); Zhenguo YANG, Suzhou, Jiangsu (CN)

(21) Appl. No.: 18/687,133

(22) PCT Filed: Jul. 29, 2022
(86) PCT No.: PCT/CN2022/109004

§ 371 Date: Feb. 27, 2024

(51) Int. Cl. H04L 61/4511; H04L 9/40; H04L 67/63

(52) U.S. Cl. CPC H04L 61/4511; H04L 63/168; H04L 63/20; H04L 67/63

(57) ABSTRACT

A service-specific DNS indicator or rule on a user computing system identifies a service-specific DNS server that can be accessed for service-specific DNS requests. The service-specific DNS server responds to the server-specific DNS request that is received directly from the user computing system, without accessing a service-independent recursive DNS service.

### BACKGROUND

Computing systems are currently in wide use. Some such computing systems include hosted systems that host applications or other services over a network. In some computing systems, client computing systems run browsers or other applications to access hosted applications or other sites.

A domain name system (DNS) is responsible for servicing name resolution requests by performing a DNS lookup. A DNS lookup happens any time one computer tries to connect to another computer using a fully qualified domain name. For example, a DNS lookup happens when applications make background calls or when a user interacts with the operating system or applications on a device (e.g., a computer, a smart phone, or another computing device). As one example, a user computing system, may receive a user input identifying a domain name for a website that the user wishes to navigate to. The domain name must be resolved into an internet protocol (IP) address so that the computing system can navigate the user to that IP address to access the desired website. Therefore, when the user enters a domain name into the user's browser, this triggers a DNS lookup. One or more remote computers known as DNS servers then find the IP address for that domain name and return the IP address to the user's computer so that the user's computer can access the correct website.

To perform a DNS lookup, the user's computer generates a DNS request that contains a request to resolve the domain name into an IP address. The DNS service attempts to serve the DNS request by returning the IP address or set of IP addresses corresponding to the service endpoint that is closest to the user computing system in terms of latency (e.g., that responds to the user or user computing system with the lowest network latency of all the available service endpoints to which the user may be connected). The client computing system may, itself, conduct a DNS lookup in which the client computing system communicates with several other DNS servers in order to resolve the domain name into an IP address that can be returned to the client. In another example, the client computing system can leverage one (or a chain of) DNS server(s) that communicate with the other DNS servers to perform the lookup in order to resolve the domain name into the IP address.

The discussion above is merely provided for general background information and is not intended to be used as an aid in determining the scope of the claimed subject matter.

### SUMMARY

A service-specific DNS indicator or rule on a user computing system identifies a service-specific DNS server that can be accessed for service-specific DNS requests. The service-specific DNS server responds to the server-specific DNS request that is received directly from the user computing system, without accessing a service-independent recursive DNS service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a flow diagram illustrating one example of the operation of a computing system architecture.

FIG. 3 is a block diagram showing one example of the computing system architecture illustrated in FIG. 1, deployed in a remote server architecture.

FIGS. 4, 5, and 6 show examples of mobile devices that can be used in a computing system architecture.

FIG. 7 is a block diagram showing one example of a computing environment.

### DETAILED DESCRIPTION

As discussed above, a DNS service receives a DNS request from a client or other computing system and the DNS service resolves the domain name in the DNS request to an IP address that can be used to navigate to a service endpoint hosting the application that the client wishes to access. The DNS service serves the DNS request by returning the IP address of the service endpoint. The DNS service attempts to serve the request by picking the service endpoint that is closest (in terms of network latency) to the requesting computing system.

In some systems, such as in an enterprise configuration, an end user device sends the DNS query to an enterprise DNS server. The enterprise DNS server forwards the query to a public recursive DNS server which further forwards the query to an authoritative DNS server which resolves the domain name to its corresponding IP address. In addition, in serving DNS requests some current systems use DNS providers that run security checks or processes to meet other functional needs.

Thus, current DNS services can encounter problems. For instance, the authoritative DNS server which ultimately resolves the domain name to its IP address may only have access to the metadata of the final recursive DNS server from which the request was received. Also, DNS requests and responses are often in clear (unencrypted) text so that any of the DNS providers in the sequence of DNS servers can potentially capture information or modify information in the requests and/or responses. This poses both a privacy concern and a security concern. Also, in many current systems, the DNS service attempts to serve the DNS request using a routing policy. The routing policy can be used to look up a closest service endpoint (e.g., frontend capacity). In many instances, this results in end users being routed to the service endpoint that is closest to the recursive DNS resolver, rather than to the end user itself.

The present description thus proceeds with respect to a system in which a service endpoint hosts a service-specific DNS service that can serve DNS requests. The user computing system is connected directly to the service endpoint so that service-specific DNS requests can be resolved by the service-specific DNS server. Thus, the service-specific DNS server has access to the user computing system IP address (from the metadata on the DNS request) so that the IP address of the service endpoint that is closest to the user computing system can be returned in response to the DNS request. Similarly, the service-specific DNS server may join the user computing system IP address with other metadata that it can leverage to conduct near real time traffic engineering, so that traffic control (e.g., routing policies) can be modified based on near real time traffic data.

The DNS requests can be routed directly from the user computing system to the service-specific DNS server using a DNS over a Hyper Text Transfer Protocol (DoH) and can be joined with other data sets, such as sever capacity, server availability, network costs, etc. in order to control traffic. Similarly, the DNS requests can be routed using a DNS over Transport Layer Security (DoT) protocol. Using either of the DoH or DoT protocols means that the requests and responses are sent over encrypted connections, instead of in plain text. This reduces the likelihood that third parties may be able to capture and observe what resources the users are trying to access, thus enhancing privacy and security.

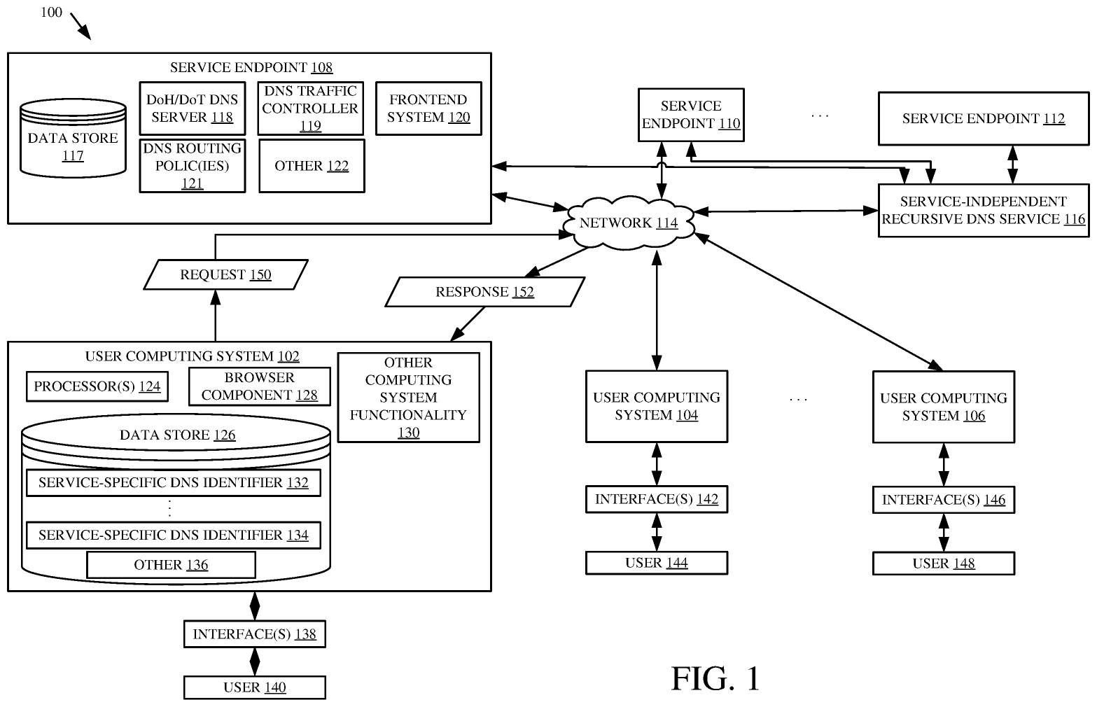

FIG. 1 is a block diagram of one example of a computing system architecture 100 in which a plurality of user (or client) computing systems 102, 104, and 106 communicate with a plurality of different service endpoints 108, 110, and 112, over network 114. In one example, the user computing systems 102, 104, and 106 provide DNS requests to a service- independent recursive DNS service 116 which, itself, resolves each of those requests by returning an IP address of a service endpoint, out of a plurality of different service endpoints 108-112. In serving the DNS requests, service-independent recursive DNS service 116 uses a routing policy to pick the closest service endpoint to the requesting computing system. This can be problematic, for some of the reasons mentioned above.

Therefore, briefly, one or more of the service endpoints 108, 110, and 112 host a service-specific DNS server. The user computing systems 102, 104, and 106 may each include a service-specific DNS indicator which identifies a service-specific DNS server to which the DNS requests from the corresponding user computing system should be directed, to resolve service-specific requests.

More specifically, in the example shown in FIG. 1, the service endpoints 108, 110, and 112 may be similar or different. For purposes of the present description it assumed that they are similar so that only service endpoint 108 is described in more detail. Service endpoint 108 may include DoH/DoT DNS server 118, DNS traffic controller 119, frontend system 120, DNS routing policies 121, and other service endpoint functionality 122. The DoH/DoT DNS server 118 is a service-specific DNS server that may use HTTP or TLS protocols to receive service-specific DNS requests from the user computing systems 102, 104, and 106. The operation of server 118 is described in greater detail below. In routing requests, DoH/DoT DNS server 118 accesses one or more routing policies 121. Policies 121 can take different forms, such as a mapping from client or user computing system IP addresses to service endpoint IP addresses. DNS traffic controller 119 can generate control signals to perform routing or traffic control and/or to modify the routing policies 121 based on metadata on the DNS requests, latency data, server capacity data, etc. Service endpoint 108 may also include a frontend system 120 which exposes an interface to a service or application that is hosted by service computing system 108. The various user computing systems 102, 104, and 106 access the hosted application or service through the interface exposed by frontend system 120.

Also, in the example illustrated in FIG. 1, user computing systems 102, 104, and 106 may be similar or different. It is assumed for the sake of the present discussion that they are similar so that only user computing system 102 is described in more detail. In the example shown in FIG. 1, user computing system 102 includes one or more processors 124, data store 126, browser component 128, and a wide variety of other computing system functionality 130. Data store 126 can include a plurality of service-specific DNS identifiers 132-134 that each identify a particular service-specific DNS server that system 102 should direct DNS requests to, based upon the service being accessed. For instance, identifier 132 may identify one DoH/DoT DNS server that serves DNS requests for a first service, while identifier 134 may identify a different DoH/DoT DNS server that serves DNS requests for a second service. Data store 126 can include other items 136 as well.

In the example shown in FIG. 1, user computing system 102 is shown generating one or more interfaces 138 that are accessible by user 140. User 140 illustratively interacts with interfaces 138 in order to control and manipulate user computing system 102 and portions of different service endpoints 108, 110, and 112. User computing system 104 is shown generating interfaces 142 for interaction by user 144. User 144 interacts with interfaces 142 in order to control and manipulate user computing system 104 and portions of service endpoint computing systems 108, 110, and 112. Similarly, user computing system 106 is shown generating interfaces 146 for interaction by user 148. User 148 interacts with interfaces 146 in order to control and manipulate user computing system 106 and portions of service endpoints 108, 110, and 112.

In the example shown in FIG. 1, it is assumed that user 140 enters a domain name in an interface 138 generated by browser component 128. In the present example, it is assumed that the domain name identifies a service for which a service-specific DNS identifier 132-134 is stored in data store 126. For instance, assume that the domain name entered by user 140 identifies a website of a first hosted service. Assume further that service-specific DNS identifier 132 identifies a service-specific DNS server (e.g., DoH/DoT DNS server 118) where user computing system 102 is to send DNS requests for the first service. In that case, browser component 128 accesses the service-specific DNS identifier (e.g., service-specific DNS identifier 132) which identifies the DoH/DoT DNS server 118 to which browser component 128 is to send the service-specific DNS requests. Browser component 128 then generates the service-specific DNS request 150 and sends it to the identified DoH/DoT DNS server 118. Server 118 serves the request 150 by accessing DNS routing policies 121 and resolving the service-specific domain name in request 150 into an IP address within the first service. The IP address identifies the service endpoint 108, 110, or 112 that is closest to user computing system 102, in terms of latency. Server 118 then generates a response 152 with the IP address of that service endpoint so that browser component 128 can navigate to that service endpoint.

DNS traffic controller 119 can store the metadata corresponding to request 150 and join it with other data sets (such as the server capacity of the different service endpoints 108, 110, and 112, the server availability for the service endpoints 108, 110, and 112, the network cost for routing traffic to the different service endpoints 108, 110, and 112, etc.). DNS traffic controller 119 can then generate or modify the DNS policies 121, in near real time, based upon the metadata obtained from the DNS request 150 and based on the other data. It will also be noted that because the DNS request 150 and response 152 are routed using DoH or DoT protocols, request 150 and response 152 are encrypted to improve both security and privacy.

Also, in one example, user 140 may enter a domain name in browser component 120 that does not have a corresponding service-specific DNS identifier 132-134 stored in data store 126. In that case, browser component 128 generates the DNS request 150 and sends it to service-independent recursive DNS service 116 for resolution into the corresponding IP address. Service 116 then returns the resolved IP address as response 152 for navigation to the desired site.

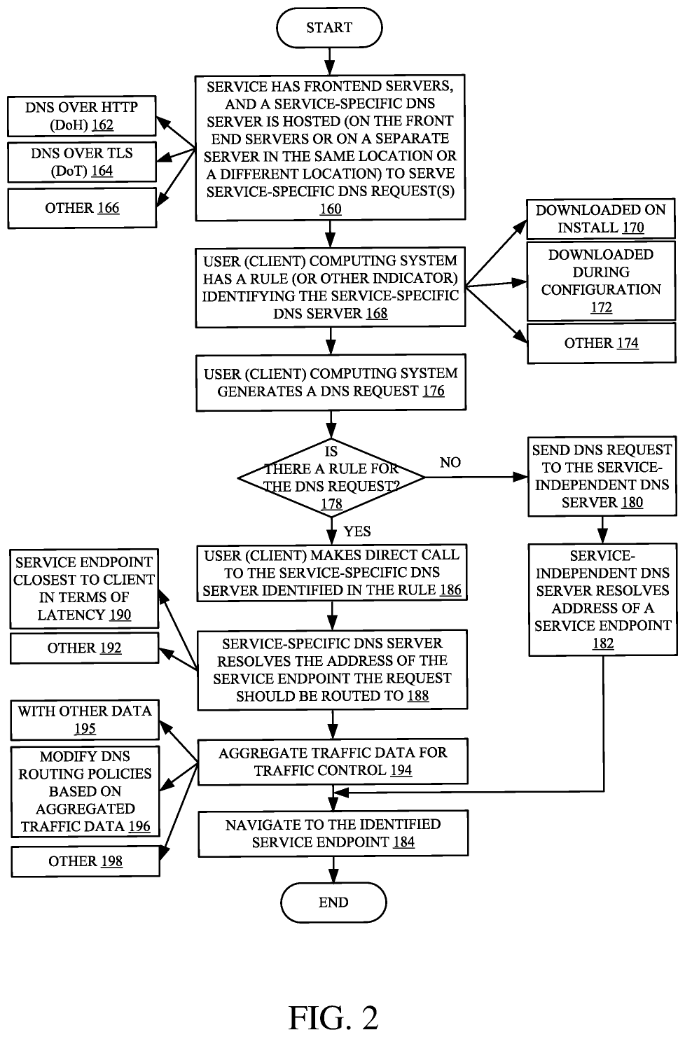

FIG. 2 is a flow diagram illustrating one example of the operation of the architecture 100 shown in FIG. 1. It is first assumed that a service has frontend servers. A service-specific DNS server can be hosted to serve service-specific DNS requests. The service-specific DNS server can be hosted by the frontend servers or by a different server in the same location as the frontend servers or at a different location. Having frontend servers hosting the service-specific DNS servers is indicated by block 160 in the flow diagram of FIG. 2. The service-specific DNS servers can be DNS over HTTP (DoH) servers 162, DNS over TLS (DoT) servers 164, or other servers 166.

The client or user computing systems also have a rule (or other identifier or indicator) identifying the service-specific DNS server to which the client or user computing system is to send DNS requests. Having such an identifier on the client or user computing system is indicated by block 168 in the flow diagram of FIG. 2. In one example, the rule or identifier is downloaded to the user or client computing system upon installation of an application or service component, as indicated by block 170. In another example, the rule or identifier may be downloaded to the user or client computing system during a configuration step, as indicated by block 172. The rule or identifier can be implemented on the user or client computing system in other ways as well, as indicated by block 174.

As discussed above, a DNS lookup can happen or be triggered for any of a variety of reasons whenever there is a request from one device to another, using a fully qualified domain name to identify the target of the request. By way of example, a DNS lookup can happen based on a time triggered function, based on an event-driven function, based on background calls from applications, based on websites uploading telemetry and other diagnostic information, etc. For purposes of the present discussion, and by way of example only, it is assumed that a user interacts with a browser to trigger a DNS lookup. Thus, at some point, user 140 types a domain name into a browser window generated by browser component 128. This may trigger user computing system 102 to generate a DNS request 150. Generating a DNS request 150 is indicated by block 176 in the flow diagram of FIG. 2. Browser component 128 then determines whether there is a rule (or other service-specific DNS identifier) 132-134 corresponding to the domain name which is the subject of the DNS request as, indicated by block 178 in FIG. 2. If not, then browser component 128 sends the DNS request 150 to the service-independent DNS server 116, as indicated by block 180. The service-independent DNS server resolves the request 150 to an IP address of a service endpoint. Resolving the DNS request 150 with the service-independent DNS server 116 is indicated by block 182 in the flow diagram of FIG. 2. The browser component 128 can then navigate to (or be routed to) the identified frontend service endpoint, as indicated by block 184 in the flow diagram of FIG. 2.

If, at block 178, browser component 128 locates a service-specific DNS identifier corresponding to the DNS request, then the user or client computing system 102 makes a direct call to the service-specific DNS server (DoH/DoT DNS server 118) identified by the rule or identifier. Generating the DNS request 150 and making a direct call to the service-specific DNS server 118 is indicated by block 186 in the flow diagram of FIG. 2.

The service-specific DNS server 118 then resolves the address of the service endpoint that the request should be routed to, as indicated by block 188 in the flow diagram of FIG. 2. For example, the service-specific DNS server 118 accesses the DNS routing policies 121 to identify the closest service endpoint to the requesting user computing system 102.] In one example, the service endpoint is the service endpoint that is closest to the client or user computing system 102 in terms of latency, as indicated by block 190. The service endpoint may be the best service endpoint to route the user or client computing system 102 to for other reasons as well, as indicated by block 192.

DNS traffic controller 119 can aggregate the traffic data (such as the metadata corresponding to the DNS request and other data) in order to perform better traffic control, as indicated by block 194. For instance, because the user or client computing system 102 sends the DNS request 150 directly to the service-specific DNS server 118, the traffic data can be aggregated with the other data (such as latency and capacity data) and used to control routing or modify routing policies 121 in near real time, or over larger time periods as well. This leads to more timely traffic control.

In addition, it should be noted that when the service-specific DNS server 118 is a DoH or DoT server, then the request 150 and response 152 are encrypted which enhances privacy and security.

It can thus be seen that the present description describes a system in which service-specific DNS requests can be directly routed to a service-specific DNS server 118 on a service endpoint 108. The requests can be sent using HTTPS or TLS protocols. The request and response can thus be encrypted. Also, by directly connecting the user computing system 102 to the DNS server 118, the service-specific DNS server 118 will know the IP address of the requesting user computing system 102 (instead of, for example, an intermediate DNS server) so that the requesting user computing system 102 can be routed to the closest service endpoint more accurately. Similarly, the DNS traffic controller 119 can quickly respond to traffic changes so that the DNS policies 121 can be modified in near real time or other traffic control signals can be generated more quickly than when using a service-independent recursive DNS service 116.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

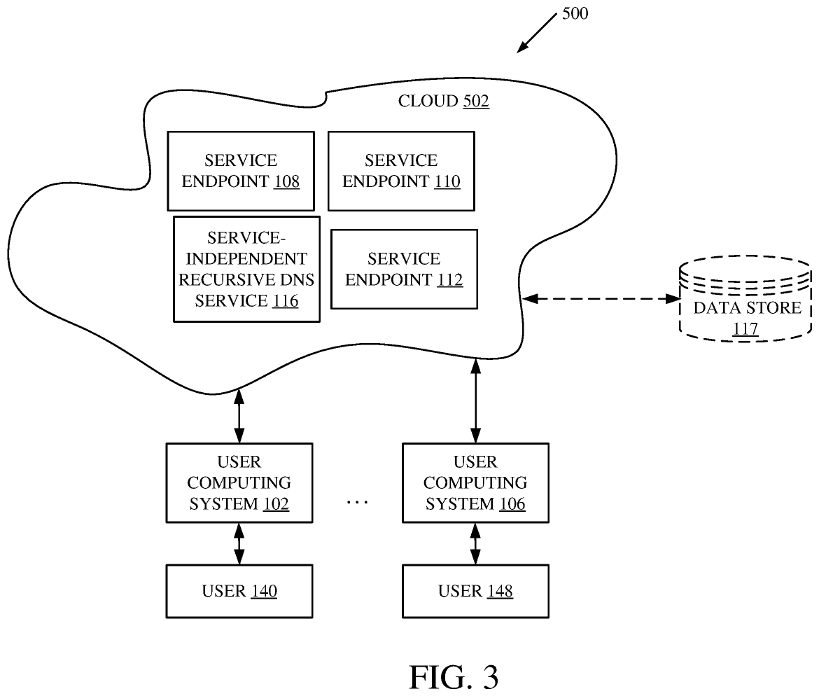

FIG. 3 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 3, some items are similar to those shown in FIG. 1 and they are similarly numbered. FIG. 3 specifically shows that service endpoints 108, 110, and 112 and service 116 can be located in cloud 502 (which can be public, private, or a combination where portions are public while others are private). Therefore, users 140-148 use user computing systems 102-104 to access those systems through cloud 502.

FIG. 3 also depicts another example of a cloud architecture. FIG. 3 shows that it is also contemplated that some elements of service endpoints 108-112 can be disposed in cloud 502 while others are not. By way of example, data store 117 can be disposed outside of cloud 502, and accessed through cloud 502. Regardless of where the items are located, the items can be accessed directly by systems 102-106, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

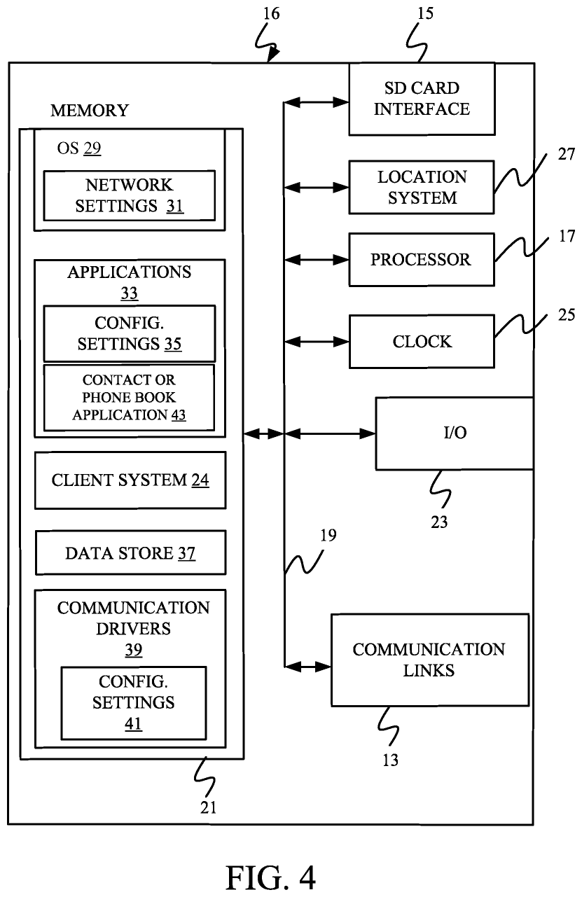

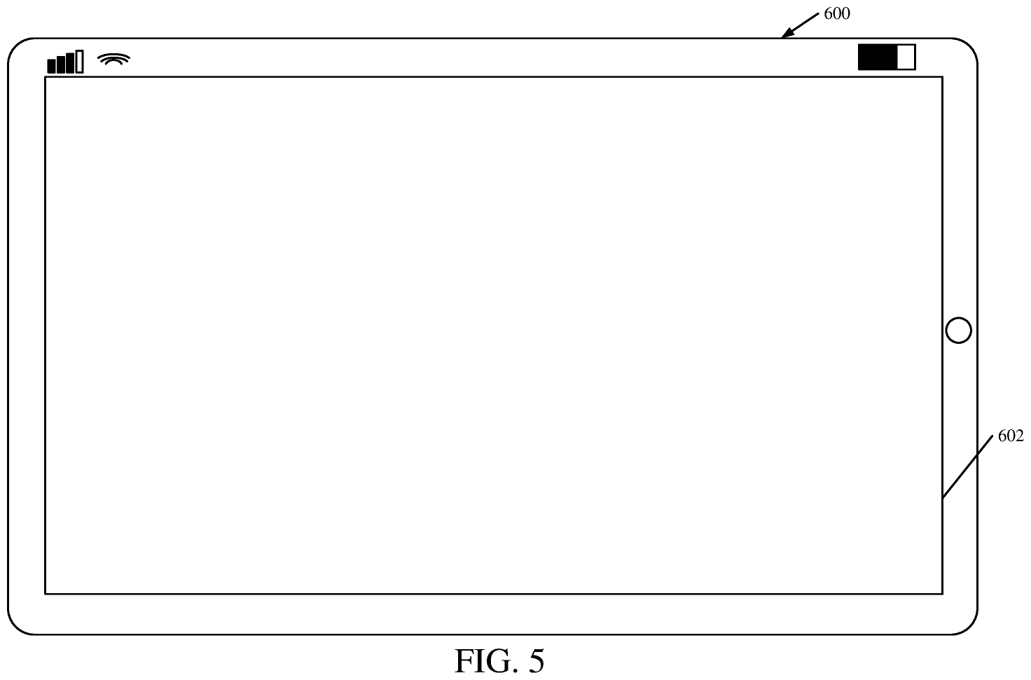

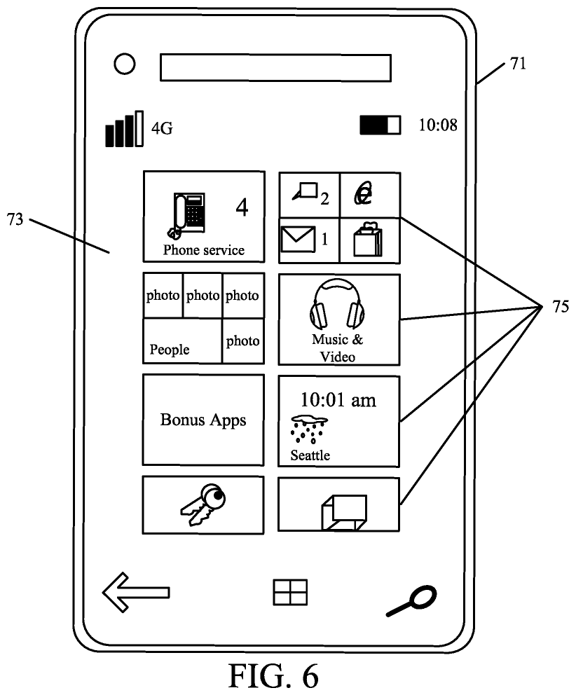

FIG. 4 is a simplified block diagram of one illustrative example of a handheld or mobile computing device that can be used as a user's or client's hand held device 16, in which the present system (or parts of it) can be deployed. FIGS. 5-6 are examples of handheld or mobile devices.

FIG. 4 provides a general block diagram of the components of a client device 16 that can run components computing system architecture 100 or that interacts with architecture 100, or both. In the device 16, a communications link 13 is provided that allows the handheld device to communicate with other computing devices and in some examples provide a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 5 shows one example in which device 16 is a tablet computer 600. In FIG. 5, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 6 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

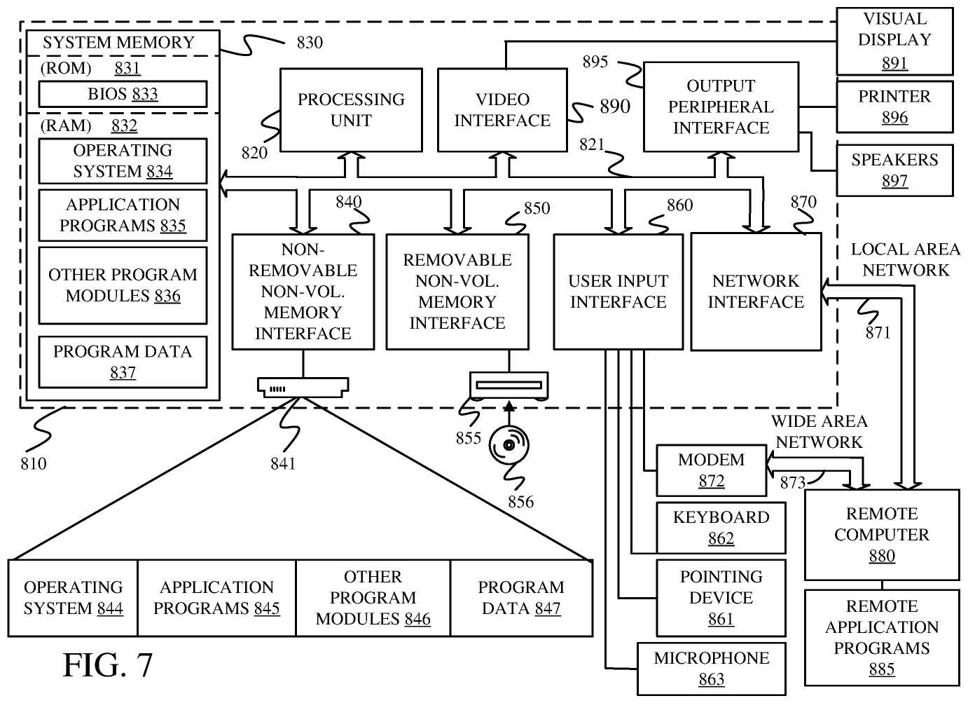

FIG. 7 is one example of a computing environment in which architecture 100, or parts of it, (for example) can be deployed. With reference to FIG. 7, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer system, comprising:
a service-specific domain name system (DNS) server;
a data store storing computer executable instructions which, when executed by the service-specific DNS server, cause the service-specific DNS server to perform steps comprising:
receiving, from a client computing system, a DNS request, based on a service-specific domain name;
accessing, with the service-specific DNS server, a DNS routing policy based on the DNS request; and
serving the DNS request using the service-specific DNS server by returning an internet protocol (IP) address of a service endpoint corresponding to the service-specific domain name based on the DNS routing policy.

Example 2 is the computer system of any or all previous examples and further comprising:
a DNS traffic controller configured to obtain request metadata from the DNS request.

Example 3 is the computer system of any or all previous examples wherein the DNS traffic controller is configured to aggregate the request metadata with other traffic metadata to obtain aggregated metadata.

Example 4 is the computer system of any or all previous examples wherein the DNS traffic controller is configured to modify the DNS routing policy based on the aggregated metadata.

Example 5 is the computer system of any or all previous examples wherein the DNS traffic controller is configured to generate a routing control signal based on the aggregated metadata.

Example 6 is the computer system of any or all previous examples wherein the DNS traffic controller is configured to aggregate the request metadata with server capacity metadata to obtain the aggregated metadata.

Example 7 is the computer system of any or all previous examples wherein the DNS traffic controller is configured to aggregate the request metadata with server availability metadata to obtain the aggregated metadata.

Example 8 is the computer system of any or all previous examples wherein the service-specific DNS server is configured to load a service-specific DNS identifier, identifying the service-specific DNS server deployed at the service endpoint, on the client computing system.

Example 9 is a computer implemented method, comprising:
receiving, through a browser component on a client computing system, a domain name;
determining whether the client computing system has a service-specific domain name system (DNS) identifier corresponding to the domain name;
if so, identifying a service-specific DNS identifier corresponding to the domain name; and
sending a DNS request to a service-specific DNS server identified by the identified service-specific DNS identifier.

Example 10 is the computer implemented method of any or all previous examples and further comprising:
receiving a response to the DNS request from the service-specific DNS server; and
navigating the browser component to the website based on an internet protocol (IP) address in the response to the DNS request.

Example 11 is the computer implemented method of any or all previous examples and further comprising:
if the client computing system does not have a service-specific DNS identifier corresponding to the website domain name, sending the DNS request to a service-independent recursive DNS server.

Example 12 is the computer implemented method of any or all previous examples and further comprising:
loading a set of service-specific DNS identifiers onto the client computing system, each service-specific DNS identifier corresponding to a different service.

Example 13 is a computer implemented method, comprising:
receiving, from a client computing system, a Domain Name Service (DNS) request, based on a service-specific domain name, at a service-specific DNS server deployed at a service endpoint;
accessing, with the service-specific DNS server, a DNS routing policy based on the DNS request; and
serving the DNS request using the service-specific DNS server by returning an internet protocol (IP) address of a service endpoint corresponding to the service-specific domain name.

Example 14 is the computer implemented method of any or all previous examples and further comprising:
obtaining request metadata from the DNS request at a DNS traffic controller.

Example 15 is the computer implemented method of any or all previous examples and further comprising:
aggregating the request metadata with other traffic metadata to obtain aggregated metadata.

Example 16 is the computer implemented method of any or all previous examples and further comprising:
modifying the DNS routing policy based on the aggregated metadata.

Example 17 is the computer implemented method of any or all previous examples and further comprising:
generating a routing control signal based on the aggregated metadata.

Example 18 is the computer implemented method of any or all previous examples wherein aggregating comprises:
aggregating the request metadata with server capacity metadata to obtain the aggregated metadata.

Example 19 is the computer implemented method of any or all previous examples wherein aggregating comprises:
aggregating the request metadata with server availability metadata to obtain the aggregated metadata.

Example 20 is the computer implemented method of any or all previous examples and further comprising:
loading a service-specific DNS identifier, identifying one or more service-specific DNS servers deployed at the service endpoint, on the client computing system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system, comprising:
a service-specific domain name system (DNS) server;
a data store storing computer executable instructions which, when executed by the service-specific DNS server, cause the service-specific DNS server to perform steps comprising:
receiving, from a client computing system, a DNS request, based on a service-specific domain name;
accessing, with the service-specific DNS server, a DNS routing policy based on the DNS request; and
serving the DNS request using the service-specific DNS server by returning an internet protocol (IP) address of a service endpoint corresponding to the service-specific domain name based on the DNS routing policy.

2. The computer system of claim 1 and further comprising:
a DNS traffic controller configured to obtain request metadata from the DNS request.

3. The computer system of claim 2 wherein the DNS traffic controller is configured to aggregate the request metadata with other traffic metadata to obtain aggregated metadata.

4. The computer system of claim 3 wherein the DNS traffic controller is configured to modify the DNS routing policy based on the aggregated metadata.

5. The computer system of claim 4 wherein the DNS traffic controller is configured to generate a routing control signal based on the aggregated metadata.

6. The computer system of claim 3 wherein the DNS traffic controller is configured to aggregate the request metadata with server capacity metadata to obtain the aggregated metadata.

7. The computer system of claim 3 wherein the DNS traffic controller is configured to aggregate the request metadata with server availability metadata to obtain the aggregated metadata.

8. The computer system of claim 1 wherein the service-specific DNS server is configured to load a service-specific DNS identifier, identifying the service-specific DNS server deployed at the service endpoint, on the client computing system.

9. A computer implemented method, comprising:
receiving, through a browser component on a client computing system, a domain name;
determining whether the client computing system has a service-specific domain name system (DNS) identifier corresponding to the domain name;
if so, identifying a service-specific DNS identifier corresponding to the domain name; and
sending a DNS request to a service-specific DNS server identified by the identified service-specific DNS identifier.

10. The computer implemented method of claim 9 and further comprising:
receiving a response to the DNS request from the service-specific DNS server; and
navigating the browser component to the website based on an internet protocol (IP) address in the response to the DNS request.

11. The computer implemented method of claim 9 and further comprising:
if the client computing system does not have a service-specific DNS identifier corresponding to the website domain name, sending the DNS request to a service-independent recursive DNS server.

12. The computer implemented method of claim 9 and further comprising:
loading a set of service-specific DNS identifiers onto the client computing system, each service-specific DNS identifier corresponding to a different service.

13. A computer implemented method, comprising:
receiving, from a client computing system, a Domain Name Service (DNS) request, based on a service-specific domain name, at a service-specific DNS server deployed at a service endpoint;
accessing, with the service-specific DNS server, a DNS routing policy based on the DNS request; and
serving the DNS request using the service-specific DNS server by returning an internet protocol (IP) address of a service endpoint corresponding to the service-specific domain name.

14. The computer implemented method of claim 13 and further comprising:
obtaining request metadata from the DNS request at a DNS traffic controller.

15. The computer implemented method of claim 14 and further comprising:
aggregating the request metadata with other traffic metadata to obtain aggregated metadata.

16. The computer implemented method of claim 15 and further comprising:
modifying the DNS routing policy based on the aggregated metadata.

17. The computer implemented method of claim 16 and further comprising:
generating a routing control signal based on the aggregated metadata.

18. The computer implemented method of claim 15 wherein aggregating comprises:
aggregating the request metadata with server capacity metadata to obtain the aggregated metadata.

19. The computer implemented method of claim 15 wherein aggregating comprises:
aggregating the request metadata with server availability metadata to obtain the aggregated metadata.

20. The computer implemented method of claim 13 and further comprising:
loading a service-specific DNS identifier, identifying one or more service-specific DNS servers deployed at the service endpoint, on the client computing system.
